(19) United States
(12) Patent Application Publication
(10) Pub. No.: US 2023/0196054 A1
(43) Pub. Date: Jun. 22, 2023

(54) MANDREL-FORMING CONTAINERS WITH RADIO FREQUENCY IDENTIFICATION (RFID)

(71) Applicant: WestRock Shared Services, LLC, Atlanta, GA (US)

(72) Inventors: John P. Dwyer, Park Heights, MN (US); Theodore M. Hammond, Nashville, TN (US); Craig W. Buscema, Douglasville, GA (US)

(73) Assignee: WestRock Shared Services, LLC, Atlanta, GA (US)

(21) Appl. No.: 18/081,955

(22) Filed: Dec. 15, 2022

Related U.S. Application Data
(60) Provisional application No. 63/291,348, filed on Dec. 17, 2021.

(51) Int. Cl. G06K 19/077; B65D 5/00; G06K 19/00

(52) U.S. Cl. CPC G06K 19/07758; B65D 5/0015; G06K 19/005

(57) ABSTRACT

A container includes a plurality of panels foldably connected to one another to enclose an interior space. A corner panel of the plurality of panels forms an oblique angle relative to a first one of the plurality of panels connected to the corner panel and relative to a second one of the plurality of panels connected to the corner panel. A radio frequency identification (RFID) tag is affixed to a surface of or proximate to the corner panel.

### BACKGROUND

### 1. Field

The present disclosure relates to containers such as paperboard containers for holding product, and more particularly to containers with radio frequency identification (RFID).

### 2. Description of Related Art

Radio Frequency Identification (RFID) can be provided to containers such as paperboard containers for holding product. The RFID tags on individual containers can provide tracking or status functionality for shipping and inventory, and can be used for security purposes. One issue that can arise is when product, such as metal cans, high protein content, or the like, blocks radio frequency scanners from detecting the RFID tags. This can be particularly problematic, for example, when containers are stacked onto pallets for shipping. The deeper containers in the pallet stack may be blocked from radio frequency scanners by the outer containers in the stack.

Additionally, there are various challenges involved with integrating RFID tagging equipment with the machines that erect containers from blanks. For example, it can be desirable to have the RFID tag located inside a container for purposes of protecting the RFID tag and/or making it less conspicuous. But placing the RFID tag inside a container in mass production can be challenging.

The conventional techniques have been considered satisfactory for their intended purpose. However, there is an ever present need for improved systems and methods for containers with RFID. This disclosure provides a solution for this need.

### SUMMARY

A container includes a plurality of panels foldably connected to one another to enclose an interior space. A corner panel of the plurality of panels forms an oblique angle relative to a first one of the plurality of panels connected to the corner panel and relative to a second one of the plurality of panels connected to the corner panel. A radio frequency identification (RFID) tag is affixed to or proximate to surface, e.g. an inward facing surface, of the corner panel.

A first plurality of end flaps can be foldably connected to respective panels of the plurality of panels at a first end of the interior space to enclose a first side of the interior space. A second plurality of end flaps can be foldably connected to respective panels of the plurality of panels at a second end of the interior space opposite the first end to enclose a second side of the interior space opposite the first side.

The plurality of panels can include a front panel, a back panel opposite the front panel across the interior space, a left panel, and a right panel opposite the left panel across the interior space. The front and back panels can be at right angles to the left and right panels. The corner panel can be foldably connected to the front panel and to the left panel, wherein the corner panel is oblique relative to the front panel and to the left panel. A second corner panel can be foldably connected to the right panel and to the front panel. The second corner panel can be oblique relative to the right panel and to the front panel. A third corner panel can be foldably connected to the back panel and to the left panel. The third corner panel can be oblique relative to the back panel and to the left panel. A fourth corner panel can be foldably connected to the right panel and to the back panel. The fourth corner panel can be oblique relative to the right panel and to the back panel. One of the first, second, third, or fourth corner panels can be a double thick panel with two layers, wherein the two layers are adhered together.

A system for forming containers from container blanks includes a blank feeder. A radio frequency identification (RFID) labeler is operatively connected to receive blanks from the blank feeder. A container former is operatively connected to receive RFID labeled blanks from the RFID labeler. The container former includes an adhesive applicator and a mandrel. The container former is configured to form containers by applying adhesive to and wrapping the RFID labeled blanks around the mandrel to the secure panels of each blank around a respective interior space with an RFID tag on an interior surface of the resulting container.

The mandrel can be configured to remain stationary relative to a housing of the container former while blanks are formed around the mandrel into containers. The mandrel can be configured to move relative to a housing of the container former to form blanks around the mandrel into containers.

The container former can be configured to form blanks into containers around the mandrel wherein each blank is as described above. The RFID labeler can be configured to apply an RFID label to the corner panel in each blank such that in a formed container output from the container former has an RFID label on an inward facing surface of its corner panel. The adhesive applicator can be configured to adhere the two layers wherein one of the first, second, third, or fourth corner panels is a double thick panel with two layers.

A pallet stack includes a stack of containers each holding product therein. Some or all of the containers each have a mitered panel. Some or all of the containers with mitered panels each have an RFID tag on or proximate to a surface of the respective mitered panel. The containers are arranged so that the mitered panels form one or more passages through the stack open to an ambient environment for ventilation of the stack and for scanning the RFID tags.

Each RFID tag can be within only one layer of corrugated paperboard material from the ambient environment. A pallet can be included upon which the stack of containers is stacked. Each of the containers can be as described above. The corner or mitered panels of the containers can form a plurality of vertical passages through the stack for ventilation and/or RFID scanning of all of the containers in the stack.

These and other features of the systems and methods of the subject disclosure will become more readily apparent to those skilled in the art from the following detailed description of the preferred embodiments taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 is a schematic perspective view of an embodiment of a container constructed in accordance with the present disclosure, showing the container in a closed state;

FIG. 2 is a schematic perspective view of the container of FIG. 1, showing the container with its upper flaps open, with product inside the interior space;

FIG. 3 is a schematic perspective view of the container of FIG. 1, showing the container with its upper flaps open, with the interior space empty, from an opposite orientation relative to that shown in FIG. 2, i.e. the front panel 102 is toward the back of the view in FIG. 3;

FIG. 4 is a plan view of a blank for the container of FIG. 1, showing the panels, flaps, and fold lines;

FIG. 5 is a plan view of another embodiment of a blank in accordance with the present disclosure, showing a blank for use with a tray forming mandrel machine;

FIG. 6 is a perspective view of a palletized stack of the containers of FIG. 1;

FIG. 7 is a plan view of the palletized stack of FIG. 6, showing the open paths through the stack; and

FIG. 8 is a schematic view of the system for forming containers in accordance with the present disclosure, showing the blank feeder, radio frequency identification (RFID) labeler, and container former.

### DETAILED DESCRIPTION OF THE PREFERRED EMBODIMENTS

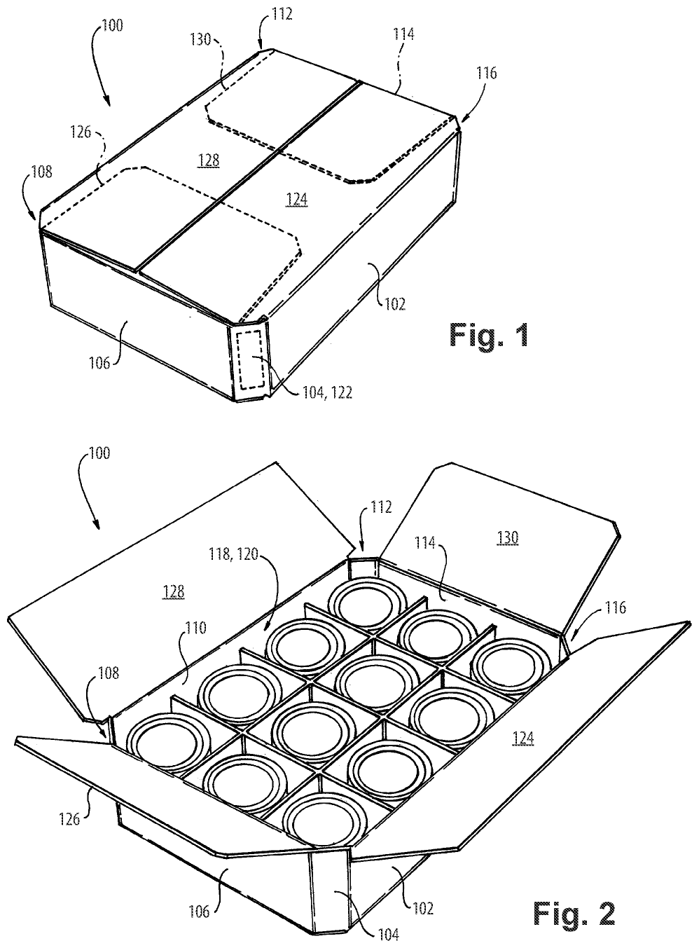

Reference will now be made to the drawings wherein like reference numerals identify similar structural features or aspects of the subject disclosure. For purposes of explanation and illustration, and not limitation, a partial view of an embodiment of a container in accordance with the disclosure is shown in FIG. 1 and is designated generally by reference character 100. Other embodiments of systems in accordance with the disclosure, or aspects thereof, are provided in FIGS. 2-8, as will be described. The systems and methods described herein can be used to provide radio frequency identification (RFID) labeling inside containers, e.g. before the containers are formed from blanks. Systems and methods as disclosed herein can also provide for open pathways for RFID communication if RFID tags in palletized stacks.

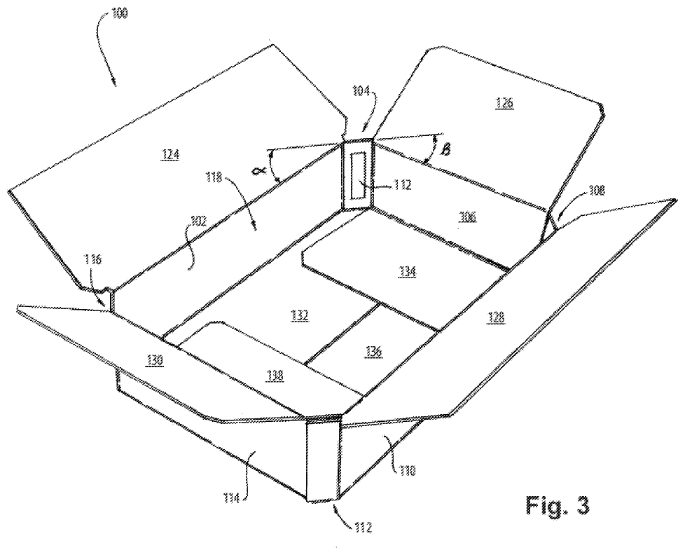

The container 100 includes a plurality of panels (front panel 102, first corner panel 104, left panel 106, second corner panel 108, back panel 110, third corner panel 112, right panel 114, and fourth corner panel 116) foldably connected along fold lines to one another to enclose an interior space 118 labeled in FIG. 3. FIG. 1 shows the container 100 in the closed state, FIG. 2 shows the container in the open state with product 120 inside the interior space 118, and FIG. 3 shows the interior space 118 empty. As shown in FIG. 3, a corner panel 104 forms an oblique angle relative to the left panel 106 and the front panel 102, the panels between which the corner panel 104 is foldably connected (as indicated by the oblique angles α and β in FIG. 3). A radio frequency identification (RFID) tag 122 is affixed to an inward facing surface of the corner panel 104.

With continued reference to FIG. 3, a first plurality of end flaps (upper front flap 124, upper left flap 126, upper back flap 128, and upper right flap 130) are foldably connected along fold lines to panels 102, 106, 110, 114, respectively at a first end of the interior space 118 to enclose a first side, i.e. the top side as oriented in FIGS. 1-3 of the interior space 118 (labeled in FIG. 3). A second plurality of end flaps (lower front flap 132, lower left flap 134, lower back flap 136, and lower right flap 138) are foldably connected by respective fold lines to panels 102, 106, 110, 114, respectively, second end (i.e. the lower end as oriented in FIGS. 1-3) of the interior space 118 enclose the second side (i.e. the bottom) of the interior space 118 (labeled in FIG. 3).

With continued reference to FIG. 3, the front panel 102 is opposite and parallel to the a back panel 110 across the interior space 118. The left panel 106 is opposite and parallel to the right panel 114 across the interior space 118. The front and back panels 102, 110 are at right angles to the left and right panels 106, 114. The corner panel 116 is foldably connected to the right panel 114 and to the front panel 102. The corner panel 116 is oblique relative to the right panel 114 and to the front panel 102. The corner panel 108 is foldably connected to the back panel 110 and to the left panel 106. The corner panel 108 is oblique relative to the back panel 110 and to the left panel 106. The corner panel 112 is foldably connected to the right panel 114 and to the back panel 110. The corner panel 112 is oblique relative to the right panel 114 and to the back panel 110.

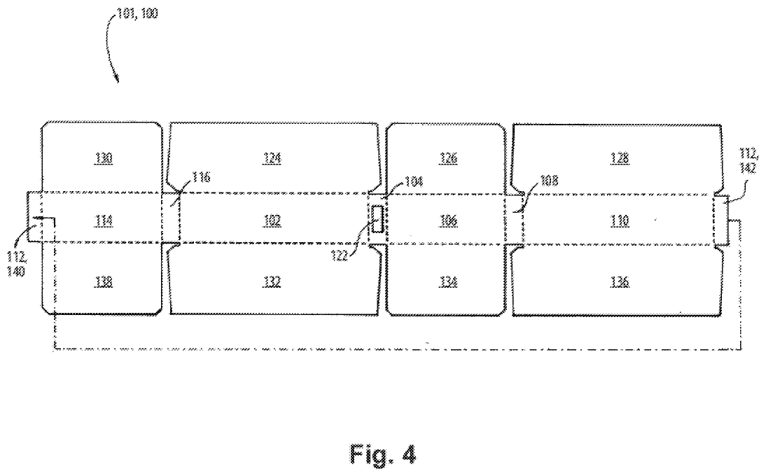

Reference is now made to FIG. 4, which shows a blank 101 that can be formed into the container 100 shown in FIGS. 1-3. The corner panel 112 is a double thick panel with two layers 140, 142 that are foldably connected directly to the right panel 114 and to the back panel 110, respectively, along fold lines. The two layers 104, 142 are brought together as indicated with the long arrow in FIG. 4, and then adhered together during formation of a container 100. Those skilled in the art will readily appreciate that any of the other corner panels 104, 108, 116 could instead be the double layer corner panel by reconfiguring the left to right order of the panels 114, 102, 106, and 110 as oriented in FIG. 4. The blank 101 is configured for a forming process in which the machine utilizes a fixed mandrel, wherein the machine forms the container 100 by wrapping the blank 101 around the fixed mandrel.

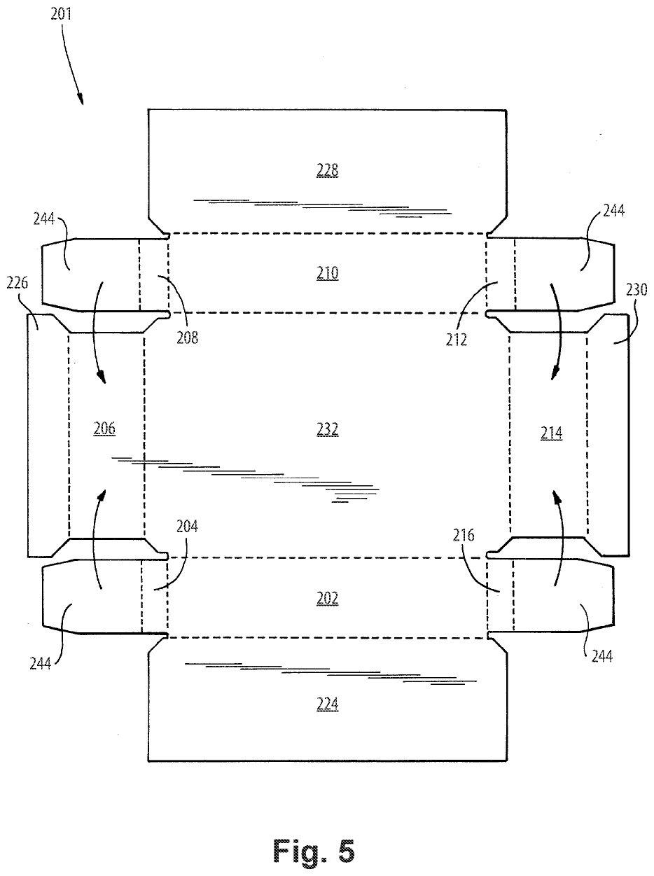

Referring to FIG. 5, another blank 201 is shown which can be formed into a container that is functionally similar to container 100 of FIGS. 1-3, by folding the flaps 244 as indicted by the heavy arrows, and adhering the adhesive flaps 244 to the panels 206, 214 indicated by the heavy arrows in FIG. 5. The resulting container has main panels 202, 206, 210, and 214 similar to panels 102, 106, 110, 114 in FIGS. 1-3, respectively. After forming the container from blank 201, the corner panels 204, 208, 212, 216 are in the same positions as the respective corner panels 104, 208, 212, and 216 as shown in FIGS. 1-3. The upper flaps 224, 226, 228, 230 are foldably connected to their respective panels 202, 206, 210, 214 to enclose the upper side of the resulting interior space when the blank 201 is formed into a container and is closed, similar to the upper flaps 124, 126, 128, 130 described above with respect to FIGS. 1-4. However, rather than having overlapping lower flaps analogous to lower flaps 132, 134, 136, 138 as in FIGS. 1-4, there is a single bottom panel 232 that is foldably connected to each of the main panels 202, 206, 210, 214 along respective fold lines. The blank 201 can be formed into a container using a tray forming machine that uses a moving mandrel. The mandrel moves into place against the bottom panel 228, and the rest of the panels are formed around the mandrel, which later moves out of the resulting interior space 118 (not labeled in FIG. 5, but see FIG. 3). The RFID tag 122 of FIG. 4 can be applied to any of the corner panels 104, 108, 112, 116, in FIG. 4, or any of the corner panels 204, 208, 212, 216 in FIG. 5. If the RFID tag 122 is applied the inner surface of the double panel of panel 112 of FIG. 4, it will be two-layers of paperboard material away from the exterior of the resulting container, however if applied to the inner surfaced of any of the other corner panels 104, 108, 116, 204, 208, 212, 216 of FIGS. 4-5 the RFID tag will only be 1-layer of paperboard material from the exterior of the resulting container. Some or all of the benefit may also be attained by placing the RFID tag 122 proximate to one of the corner panels instead of directly on the corner panel. In some applications, it may be possible to apply the RFID label 122 to the outside of the container rather than the inside, and still achieve benefits as described herein.

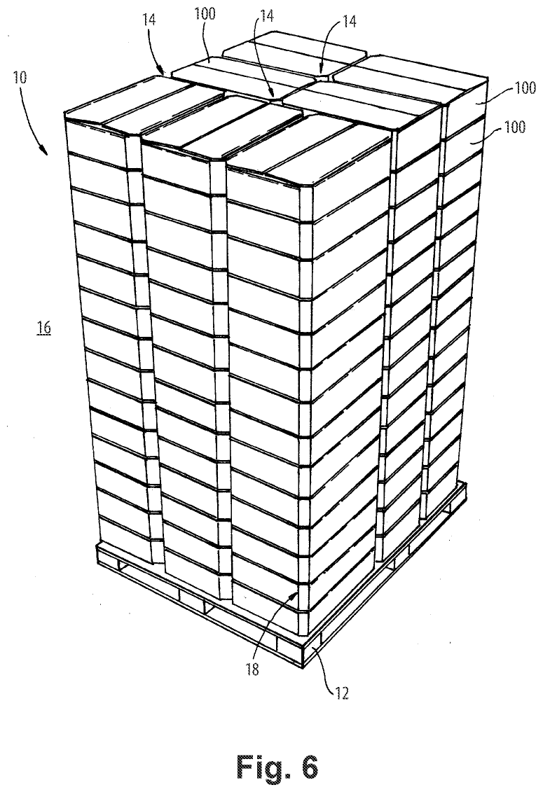

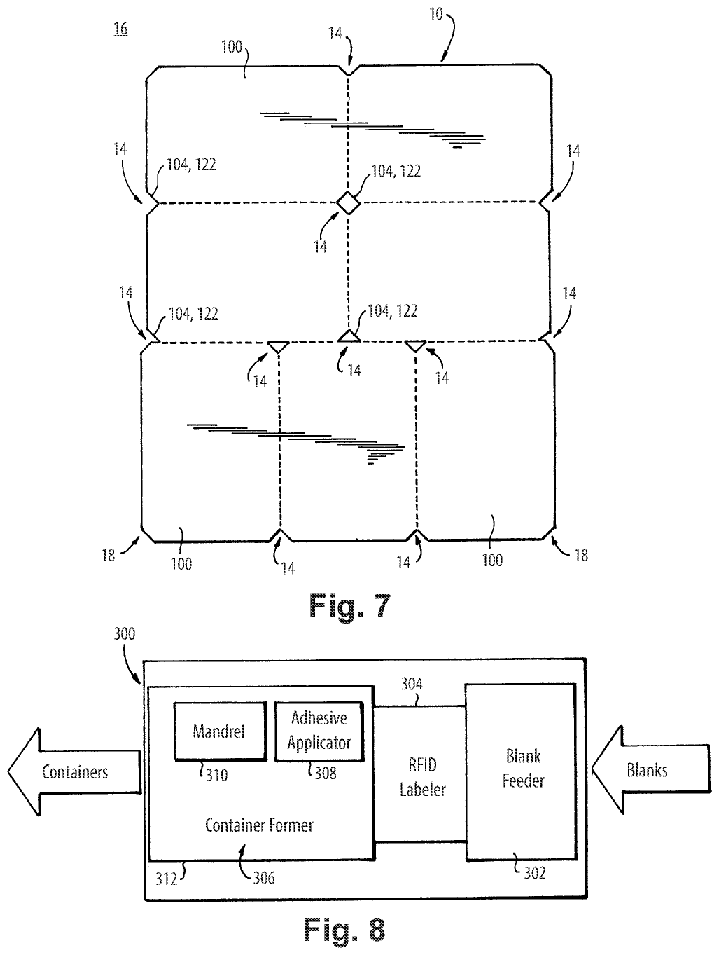

With reference now to FIG. 6, a pallet stack 10 includes a stack of containers 100 (e.g. made from blanks such as those shown in FIGS. 4 and 5) each holding product therein. A pallet 12 is included upon which the stack 10 of containers 100 is stacked. Each of the containers 100 can be as described above. Each container 100 has a mitered panel, e.g. the oblique corner panels 104 labeled in FIGS. 1-4. Some or all of the containers 100 each have an RFID tag, e.g. RFID tag 122 shown in FIG. 3, on an interior surface of the respective mitered panel. The containers are arranged so that the mitered panels form vertical passages 14 through the stack 10 that are open to the ambient environment 16 for ventilation of the stack 10 and for scanning the RFID tags 122 (which are also shown in FIG. 3). FIG. 7 shows a plan view of the stack 10 to show the passages 14. Some of the passages 14 are labeled on the outside perimeter of the stack 10, and there are four passages 14 labeled that are internal to the stack 10. In each container 100 in FIG. 7, RFID tag 122 is within only one layer of corrugated paperboard material from the ambient environment 16 because of the access provided by the mitered corner panels 104 to the passages 14. The passages 14 are shown in plan view in FIG. 7, but extend from the top as oriented in FIG. 6 to the bottom of the stack 10 at the pallet 12. In one corner 18 of the stack 10 the RFID tags 122 are on corner panels 104 that face directly outward to the ambient environment.

Those skilled in the art will readily appreciate that the footprint of containers 100 in the stack 10 shown in FIGS. 6 and 7 can be rearranged without departing from the scope of this disclosure, to allow passages interior to the stack 10, at exterior edges of the stack 10, or at corners of the stack 10 to be utilized to allow radio frequency scanning to all of the RFID tags 122 in the stack 10. Those skilled in the art having had the benefit of this disclosure will readily appreciate that RFID tags 122 can be applied to any of the corner panels 104, 108, 112, 116, 204, 208, 212, 216 identified in FIGS. 4-5 without departing from the scope of this disclosure. Even if the RFID tag 122 is applied to a corner panel 112 that has double thickness, in the stack 10 there are only two layers of material between the RFID tag 122 and the ambient environment 16 thanks to the access provided by passages 14. Those skilled in the art will also appreciate that while 8-sided containers 100 and blanks 101, 201 therefore are shown and described with reference to FIGS. 1-5, containers of any suitable number of sides can be used without departing from the scope of this disclosure, wherein a mitered panel in the containers can be used to form a passage 14 in a stack 100. It is also possible to improve RFID reading by having the RFID tag 122 closer to the top of the container than to the bottom, as oriented in FIGS. 1-3.

With reference now to FIG. 8, a system 300, is shown for forming containers (such as containers 100 described above) from container blanks (such as blanks 101, 201 described above). The system 300 includes a blank feeder 302, which can fees individual blanks from a supply into the rest of the system 300. A radio frequency identification (RFID) labeler 304 is operatively connected to receive blanks from the blank feeder 302, and to affix RFID tags such as RFID tags 122 described above to the blanks. The RFID labeler 304 is configured to apply an RFID label to the corner panel, e.g. panel 104, 204 labeled in FIGS. 4 and 5, in each blank so that in a formed container that is output from the container former 306 there is an RFID label on an inward facing surface of the corner panel.

A container former 306 is operatively connected to receive RFID labeled blanks from the RFID labeler 304. The container former includes a mandrel 308 and an adhesive applicator 310. The adhesive applicator 310 is configured to adhere the two layers (e.g. the two layers 140 of corner panel 112 in FIG. 4, or the two layers 244 and their respective main panels 206, 214 indicated in FIG. 5).

The container former 306 is configured to form containers by applying adhesive with the adhesive applicator 310 to and then wrapping the RFID labeled blanks around the mandrel 308 to the secure panels of each blank around a respective interior space, such as the interior space 118 identified in FIG. 3, with an RFID tag on an interior surface of the resulting container. The mandrel 308 can be configured to remain stationary relative to a housing 312 of the container former 306 while blanks are formed around the mandrel into containers. The stationary mandrel configuration utilizes blanks such as blank 101 shown in FIG. 4. It is also contemplated that the mandrel 308 can be configured to move relative to the housing 312 of the container former 306 to form blanks around the mandrel into containers. The moving mandrel configuration corresponds to the tray forming process described above referencing the blank 201 in FIG. 5.

It may be possible to omit the RFID labeler 304. For example, the blanks are formed from paperboard in a die-cutter. If an RFID labeler is operatively associated with that the die-cutter process, for example at a first facility, the blanks can be already RFID labeled when they arrive at the blank feeder 302, for example if system 300 is at a second facility remote from the first facility.

The methods and systems of the present disclosure, as described above and shown in the drawings, provide for radio frequency identification (RFID) labeling inside containers, e.g. before the containers are formed from blanks. Systems and methods as disclosed herein can also provide for open pathways for RFID communication if RFID tags in palletized stacks. While the apparatus and methods of the subject disclosure have been shown and described with reference to preferred embodiments, those skilled in the art will readily appreciate that changes and/or modifications may be made thereto without departing from the scope of the subject disclosure.

What is claimed is:

1. A container comprising:
a plurality of panels foldably connected to one another to enclose an interior space, wherein a corner panel of the plurality of panels forms an oblique angle relative to a first one of the plurality of panels connected to the corner panel and relative to a second one of the plurality of panels connected to the corner panel; and
a radio frequency identification (RFID) tag affixed to a surface of the corner panel.

2. The container as recited in claim 1, further comprising a first plurality of end flaps foldably connected to respective panels of the plurality of panels at a first end of the interior space to enclose a first side of the interior space.

3. The container as recited in claim 2, further comprising a second plurality of end flaps foldably connected to respective panels of the plurality of panels at a second end of the interior space opposite the first end to enclose a second side of the interior space opposite the first side.

4. The container as recited in claim 1, wherein the plurality of panels includes a front panel, a back panel opposite the front panel across the interior space, a left panel, and a right panel opposite the left panel across the interior space, wherein the front and back panels are at right angles to the left and right panels.

5. The container as recited in claim 4, wherein the corner panel is foldably connected to the front panel and to the left panel, wherein the corner panel is oblique relative to the front panel and to the left panel.

6. The container as recited in claim 4, wherein the corner panel is a first corner panel and further comprising:
a second corner panel foldably connected to the right panel and to the front panel, wherein the second corner panel is oblique relative to the right panel and to the front panel;
a third corner panel foldably connected to the back panel and to the left panel, wherein the third corner panel is oblique relative to the back panel and to the left panel; and
a fourth corner panel foldably connected to the right panel and to the back panel, wherein the fourth corner panel is oblique relative to the right panel and to the back panel.

7. The container as recited in claim 6, wherein one of the first, second, third, or fourth corner panels is a double thick panel with two layers, wherein the two layers are adhered together.

8. A system for forming containers from container blanks comprising:
a blank feeder;
a radio frequency identification (RFID) labeler operatively connected to receive blanks from the blank feeder; and
a container former operatively connected to receive RFID labeled blanks from the RFID labeler, wherein the container former includes an adhesive applicator and a mandrel and is configured to form containers by applying adhesive and wrapping the RFID labeled blanks around the mandrel to the secure panels of each blank around a respective interior space with an RFID tag on an interior surface of the resulting container.

9. The system as recited in claim 8, wherein the mandrel is configured to remain stationary relative to a housing of the container former while blanks are formed around the mandrel into containers.

10. The system as recited in claim 8, wherein the mandrel is configured to move relative to a housing of the container former to form blanks around the mandrel into containers.

11. The system as recited in claim 8, wherein the container former is configured to form blanks into containers around the mandrel wherein each blank includes:
a plurality of panels foldably connected to one another to enclose an interior space, wherein a corner panel of the plurality of panels forms an oblique angle relative to a first one of the plurality of panels connected to the corner panel and relative to a second one of the plurality of panels connected to the corner panel.

12. The system as recited in claim 11, wherein the RFID labeler is configured to apply an RFID label to the corner panel in each blank such that in a formed container output from the container former has an RFID label on an inward facing surface of its corner panel.

13. The system as recited in claim 12, wherein the blanks further comprise a first plurality of end flaps foldably connected to respective panels of the plurality of panels at a first end of the interior space to enclose a first side of the interior space.

14. The system as recited in claim 13, wherein the plurality of panels includes a front panel, a back panel opposite the front panel across the interior space, a left panel, and a right panel opposite the left panel across the interior space, wherein the front and back panels are at right angles to the left and right panels, wherein the corner panel is foldably connected to the front panel and to the left panel, wherein the corner panel is oblique relative to the front panel and to the left panel, wherein the corner panel is a first corner panel and further comprising:
a second corner panel foldably connected to the right panel and to the front panel, wherein the second corner panel is oblique relative to the right panel and to the front panel;
a third corner panel foldably connected to the back panel and to the left panel, wherein the third corner panel is oblique relative to the back panel and to the left panel; and
a fourth corner panel foldably connected to the right panel and to the back panel, wherein the fourth corner panel is oblique relative to the right panel and to the back panel.

15. The system as recited in claim 14, wherein one of the first, second, third, or fourth corner panels is a double thick panel with two layers, wherein the adhesive applicator is configured to adhere the two layers.

16. A pallet stack comprising:
a stack of containers each holding product therein, wherein at least some of the containers each have a mitered panel, wherein some or all of the containers with mitered panels each have an RFID tag on a surface of the respective mitered panel, and wherein the containers are arranged so that the mitered panels form one or more passages through the stack open to an ambient environment for ventilation of the stack and for scanning the RFID tags.

17. The pallet stack as recited in claim 16, wherein each RFID tag is within only one layer of corrugated paperboard material from the ambient environment.

18. The pallet stack as recited in claim 16, further comprising a pallet upon which the stack of containers is stacked.

19. The pallet stack as recited in claim 16, wherein each of the containers includes a plurality of panels foldably connected to one another to enclose an interior space, wherein the respective mitered panel is a corner panel of the plurality of panels that forms an oblique angle relative to a first one of the plurality of panels connected to the corner panel and relative to a second one of the plurality of panels connected to the corner panel.

20. The pallet stack as recited in claim 19, wherein the corner panels of the containers form a plurality of vertical passages through the stack for ventilation and/or RFID scanning of all of the containers in the stack.
